(19) United States
(12) Patent Application Publication
(10) Pub. No.: US 2006/0086826 A1
(43) Pub. Date: Apr. 27, 2006

(54) Filler injector system for spray layup

(75) Inventors: Mike Akin Oden, Littlefield, TX (US); David Lee Peacock, Mexico, MO (US)

Correspondence Address: Elizabeth R. Hall & Associates, P.C., 1722 Maryland Street, Houston, TX, 77006-1718, US

(73) Assignee: Impact Composite Technology, Ltd., Houston, TX (US)

(21) Appl. No.: 11/243,602

(22) Filed: Oct. 5, 2005

Related U.S. Application Data
(60) Provisional application No. 60/616,804, filed on Oct. 7, 2004.

(51) Int. Cl. B05B 7/06

(52) U.S. Cl. 239/428; 239/422; 239/DIG. 8

(57) ABSTRACT

The filler injection system of the present invention uses a pneumatically operated system to deliver fine grained flaked bulk filler material to the nozzle of a modified chopper type spray gun for making sprayed layups of reinforced plastic parts. The filler injection system delivers the filler material directly into the flow stream from the spray gun, thereby permitting a homogeneous and intimate admixture of the filler with the stream of resin and chopped reinforcing fibers from the spray gun.

### CROSS REFERENCE TO RELATED APPLICATIONS

The present application, pursuant to 35 U.S.C. 111(b), claims the benefit of the filing date of provisional application Ser. No. 60/616,804 filed Oct. 7, 2004, entitled “Filler Injector System for Spray Layup.”

### BACKGROUND OF THE INVENTION

1. Field of the Invention

The present invention relates in general to a method and apparatus for preparing filler and fiberglass reinforced plastic parts. More particularly, the invention relates to a method and apparatus for injecting fine grained bulk filler material into the flow stream of a spray gun used for making sprayed layups of reinforced plastic parts.

2. Description of the Related Art

The fiberglass reinforced plastics industry produces a variety of products including shower stalls, bathtubs, spas, skis, boats, camper tops, corrosion resistant tanks, etc. The most common method of reinforced plastics production is open molding. First the surface of the mold is polished and coated with a wax, which allows easy removal of the finished product from the mold after curing. Then a gel coat (a mixture of unsaturated polyester resin, catalyst and pigments) is sprayed onto the waxed mold to form the outer, visible surface of the finished product. Another common open mold method is to back an acylic sheet that has been heated and pressed into the form of the mold.

After the gel coat is fully cured, fiberglass reinforcing material saturated with catalyzed polyester resin is sprayed into the mold or in the case of an acrylic mold sprayed behind the molded acrylic. The polyester resin, catalyst, and fiberglass strands are fed into a chopper gun for spraying. The chopper gun is so named because it chops the fiberglass into short segments, mixes those segments into the resin stream, and sprays that fiberglass resin mixture into the mold. One problem that plagues the fiberglass reinforced plastics industry in the large amount of styrene, a major environmental pollutant, emitted during the application or spraying stage of the process.

There is a continuing need to find ways of improving fiberglass reinforcing materials, as well as reducing the environmental impact of the process.

### SUMMARY OF THE INVENTION

The invention contemplates a method and apparatus for injecting fine grained bulk filler material into the flow stream of fiberglass reinforced resin applied by a spray gun in making sprayed layups of reinforced plastic parts.

One aspect of the present invention provides for the adjustable flow of filler into the fiberglass reinforced resin through the coordinated controlled use of a venturi and a feed auger.

The foregoing has outlined rather broadly several aspects of the present invention in order that the detailed description of the invention that follows may be better understood. Additional features and advantages of the invention will be described hereinafter which form the subject of the claims of the invention. It should be appreciated by those skilled in the art that the conception and the specific embodiment disclosed might be readily utilized as a basis for modifying or redesigning the structures for carrying out the same purposes as the invention. It should be realized by those skilled in the art that such equivalent constructions do not depart from the spirit and scope of the invention as set forth in the appended claims.

### BRIEF DESCRIPTION OF THE DRAWINGS

For a more complete understanding of the present invention, and the advantages thereof, reference is now made to the following descriptions taken in conjunction with the accompanying drawings, in which:

FIG. 1 is a side profile view of a first embodiment of the present invention, showing the feed and control systems in the mounting frame;

FIG. 2 is an oblique view corresponding to FIG. 1 showing the feed and control systems;

FIG. 3 is an oblique view from below and to one side of the feed system of FIG. 1, wherein the mounting frame is omitted for clarity;

FIG. 4 is an oblique view of a conventional chopper type spray gun for spray layup of reinforced plastics with the injector nozzle of the present invention attached;

FIG. 5 is a side profile view of the modified chopper type spray gun corresponding to FIG. 4;

FIG. 6 is an oblique view of the modified chopper type spray gun of FIG. 4 taken from the opposed side;

FIG. 7 is a longitudinal vertical sectional view of the feed manifold of the present invention taken along the axis of the feed auger;

FIG. 8 is a longitudinal vertical sectional view of the injection manifold of the present invention taken along the axis of the injector;

FIG. 9 is a schematic diagram of the pneumatic system of the first embodiment of the present invention;

FIG. 10 is an oblique view of the feed system of a second embodiment of the present invention, wherein a vent is inserted into the pneumatic feed system to reduce the feed rate of the filler; and

FIG. 11 is a schematic diagram of the pneumatic system of the second embodiment of the present invention.

### DESCRIPTION OF THE PREFERRED EMBODIMENTS

The filler injection system of the present invention uses a pneumatically operated system to deliver fine grained flaked bulk filler material to the nozzle of a modified chopper type spray gun for making sprayed layups of reinforced plastic parts. The filler injection system delivers the filler material directly into the flow stream from the spray gun, thereby permitting a homogeneous and intimate admixture of the filler with the stream of resin and chopped reinforcing fibers from the spray gun.

Preferred filler material is a natural fiber as wood fiber or agricultural fibers such as flax, kenaf, hemp, jute, peanut, or cotton hull fibers. It can also be a combination of natural fiber based particulates and inorganic particulates. A particularly suitable filler material for this process is RF Fiber a mechanically modified residue of cotton plants produced during the stripping of the cotton bolls at harvest. RF Fiber is manufactured and distributed by Impact Composite Technology, Ltd., Houston, Tex.

RF Fiber is a particularly good filler material for the described process because of its high lignin content. The highly absorbent nature of the RF Fiber and the speed of the chemical reaction of its lignin with the styrene emitted from the resin, the resultant uniform mixture of RF Fiber filler with a resin stream permits the filler to absorb most of the styrene present in the resin. For this reason, the filler injection system of the present invention markedly reduces the amount of styrene released to the atmosphere during the spray operation.

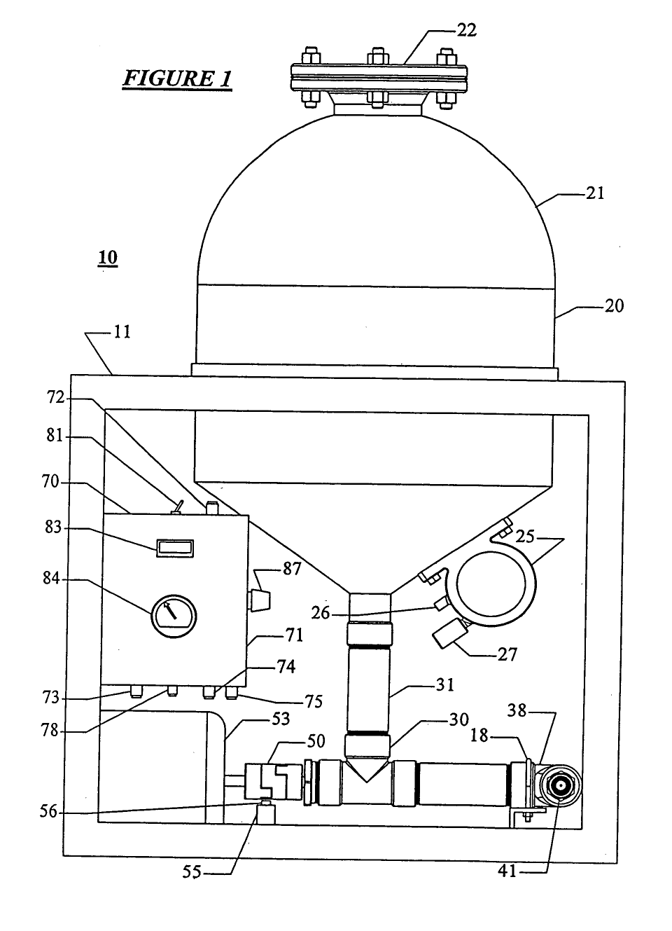

Referring to FIGS. 1-3, the first embodiment 10 of the present invention is shown. As shown therein, the feed system 20 is mounted in a welded steel perimeter frame 11 constructed of structural angles and plate. The perimeter frame 11 serves to support and protect the components of the feed system 20. The upper end of the tank 21 of the feed system extends above the top of the frame 11 in order to provide ready access to the flange 22 on the top of the tank so that filler can be added to the tank.

A transverse steel mounting plate 12 flush with the bottom of the frame 11 extends from one transverse side of the frame to the other adjacent to a first end of the frame. Spaced a short distance away from the opposed second end of the frame 11 is a transversely mounted support angle 13 which extends from one transverse side of the frame to the other at the bottom of the frame. Circular tank support ring 14 is attached to the upper side of frame 11 and laterally supports tank 21. Tank 21 is a slip fit inside ring 14.

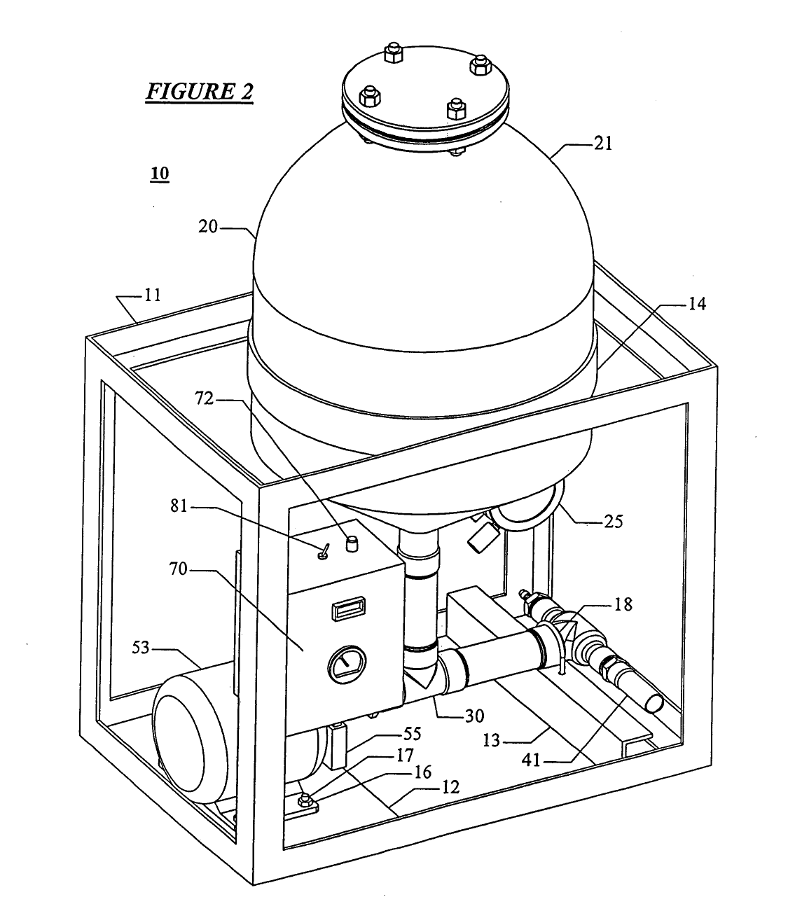

Angle 13 has one leg horizontal on its upper side. Both mounting plate 12 and support angle 13 are provided with appropriately positioned mounting holes or other attachment means for the mounting of the feed system 20. As shown in FIG. 2, the air motor 53, used to drive the feed auger 35 of the feed system 20, is mounted to plate 12 by means of threaded studs 17 and comated nuts 16. The upwardly projecting studs 17 are welded to the plate 12 in an array positioned to engage holes in the mounting foot of the air motor 53. The angle 13 is attached to one end of the feed system 20 using a U-bolt and the nuts 18.

The tank 21 has a vertical axis and has a right circular cylindrical middle section, a frustroconical lower section decreasing in diameter downward, and a hemispherical upper section. A tubular neck having female pipe threads on its lower end extends downwardly from the lower end of the conical portion of the tank. Centrally located on the upper end of the hemispherical end of the tank is a central hole with an upwardly facing flange. Cover flange 22 comates with the flange of the tank 21 so that the tank may be sealed when desired. The RF Fiber or other filler compound is inserted into the tank 21 through the upper flange of the tank and is discharged into the feed auger system 30 through the tubular neck of the tank.

Rigidly mounted on the lower exterior side of the tank 21 is a pneumatic vibrator 25 that is used to ensure that the filler will feed smoothly into the tubular neck of the tank 21 and thence into the feed auger system 30. The vibrator 25 is supplied with pressurized air for power through an air line (not shown) from the vibrator supply fitting 74 of the control system 70 to the inlet 26 of the vibrator. The exhaust from the vibrator 25 passes through a muffler 27 in order to reduce operating noise levels.

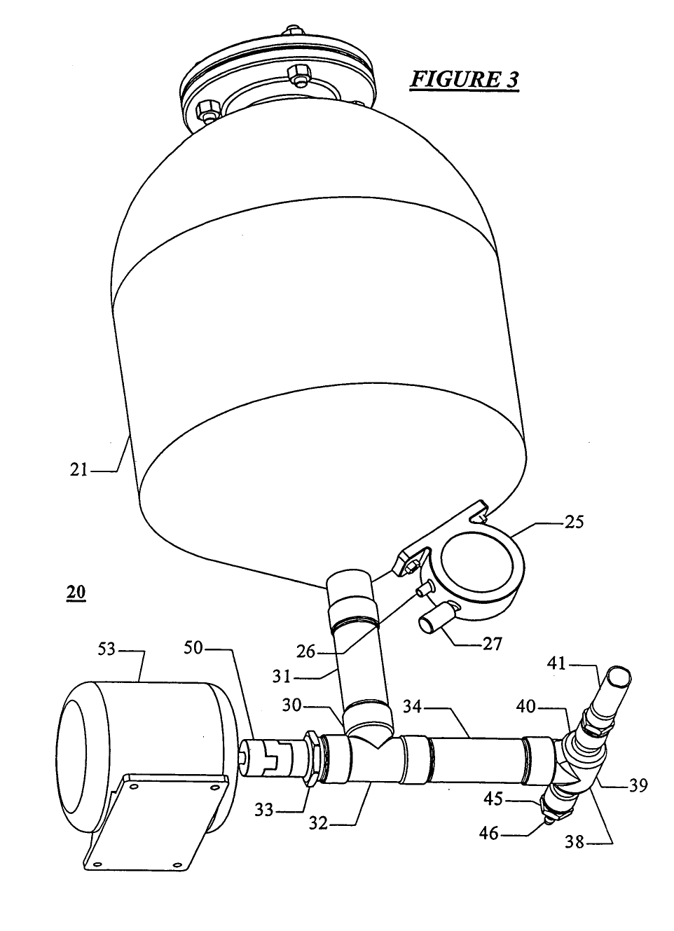

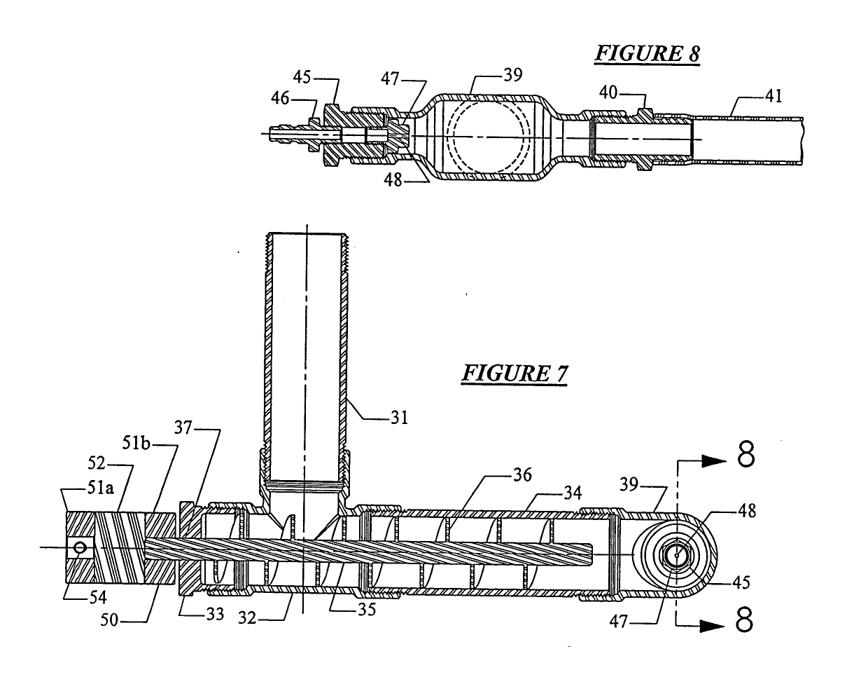

The feed auger system 30, shown in FIGS. 3 and 7, is generally constructed primarily from commercially available piping components, such as steel components based on a 2-inch NPT (National Pipe Thread) thread pattern. A vertical first long pipe nipple 31 is threadedly engaged at its upper end with the female thread on the tubular neck of the tank 21. The thread at the bottom end of the nipple 31 is threadedly engaged with the upwardly extending non-through socket bore of the first female pipe tee 32.

The pipe tee 32 has its through bore horizontal and, at its outlet end which is shown on the right in FIG. 3, is threadedly engaged with a second long pipe nipple 34. At the other horizontal end of tee 32 opposed to the outlet end, modified hex pipe plug 33 is threadedly engaged. Modified plug 33 is typically a standard hex pipe plug with a coaxial through bore which serves as a support journal 37 for the shaft of auger 35.

Feed auger 35 has an elongate cylindrical shaft onto which a single helically spiraled radially projecting feed auger flute 36 is welded. The auger flute 36, as seen in FIG. 7, extends from the right hand end of the auger to approximately 1 to 2 inches from the left end. The unfluted end of the auger 35 is journaled in the auger shaft support journal 37 and extends beyond the pipe plug 33, where it is attached to a shaft coupling 50.

Referring to FIGS. 7 and 8, the venturi nozzle 38 of the first embodiment of the filler injector system 10 consists of a second female pipe tee 39 onto which are mounted the other components of the nozzle. The second female pipe tee 39 has a 2 inch NPT female non-through bore horizontal and threadedly engaged with the downstream (right hand) end of the second long pipe nipple 34. The two coaxial through bores of tee 39 are horizontal and preferably have 1 inch female NPT threads.

Threadedly engaged in the outlet end of tee 39 is a male crossover hose fitting 40. Hose fitting 40 typically has a 1 inch male NPT thread at one end and a hose barb at its other end. Pneumatic pressure hose 41 is mounted on the hose barb of hose fitting 40 and serves to convey air with entrained filler from the feed system 20 to the spray gun 100. In order to avoid static electrical discharges, hose 41 may be made of conductive material.

Threadedly engaged in the other through bore end of tee 39 is a modified hex pipe bushing 45. Male quick connect fitting 46 is threaded into the exposed hex end of bushing 45 so that a hose quick connection can be established readily for the purpose of inducing air flow through the coaxial hole in the bushing. The hex pipe bushing has a female thread on the interior end of its coaxial through hole, where male hex orifice fitting 47 is threadedly engaged. Male hex orifice fitting 47 consists of a conventional hex pipe plug having a small diameter coaxial through hole that serves as the venturi orifice 48. The coaxial injection of a pressurized air stream through the venturi orifice 48 from quick connect fitting 46 produces a low pressure region in the interior of second female pipe tee 39.

Shaft coupling 50 serves to connect the feed auger 35 to air motor 53 so that the auger can be driven thereby. Coupling 50 consists of two identical coupling jaws 51a,b separated both axially and between their intermeshed jaws by an elastomeric flex element 52. Each coupling jaw 51a,b has one or more radially mounted set screws 54 to fix the jaws to the mounting shafts to prevent relative rotation between the jaws and shafts. Coupling jaw 51b is mounted to the exposed end of the shaft of the feed auger 35, while jaw 51a is mounted to the output shaft of air motor 53.

The air motor 53 is not shown with reduction gearing, although such gearing is often used. A preferred embodiment of the invention uses an air motor/gear box combination 53. The air motor 53 is supplied with air from the control system 70 by means of an air motor supply fitting 73 and a connecting hose (not shown). Rotation of the air motor 53 causes the auger 35 to be rotated within the bore of the feed auger system 30, thereby inducing filler passing down first long pipe nipple 31 to be urged toward the venturi nozzle 38.

Air motor 53 is mounted by means of threaded studs 17 and nuts 16 to the mounting plate 12 of frame 11. A rectangular metal block 55, mounted below the inwardly projecting jaw of the shaft coupling jaws 51a, supports a RPM switch 56. The RPM switch 56 is of either the Hall effect type or a magnetic proximity sensor, so that an electrical pulse is generated each time a jaw of the steel shaft coupling jaws 51a passes the switch. These electrical pulses are conveyed by a pair of wires to the auger RPM meter display 83 mounted on the front face of the control box 71 of the control system 70.

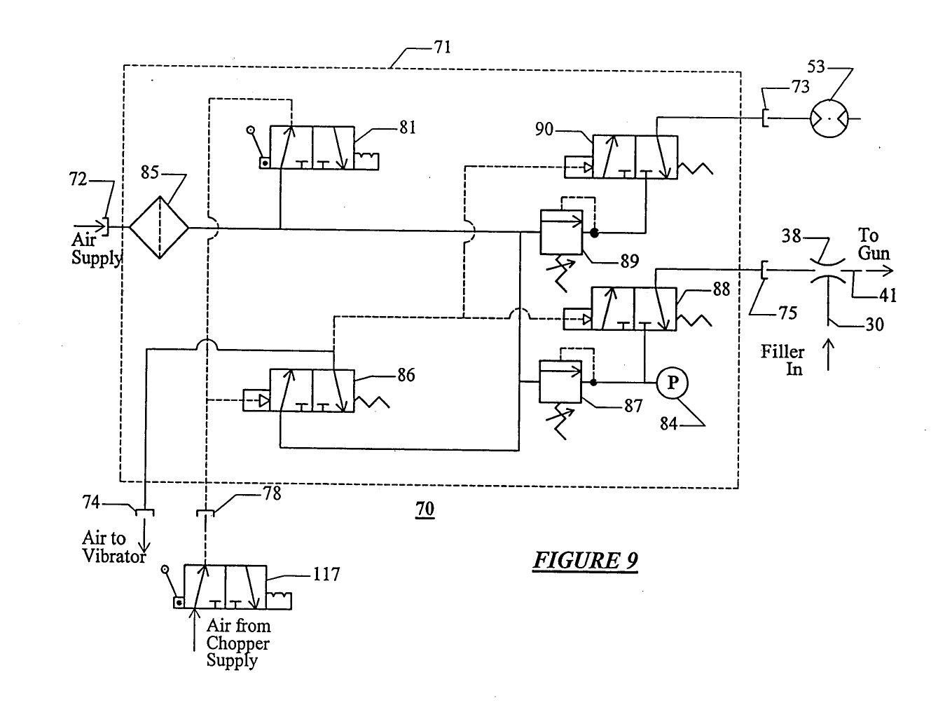

Control system 70, housed in rectangular prismatic control box 71, uses pneumatic control in order to provide power and control to the filler injector system 10. Control box 71 is positioned within the perimeter of frame 11, as shown in FIGS. 1 and 2. FIG. 9 shows a schematic of the control system 70. Control system 70 is used to provide air to operate the vibrator 25, the air motor 53 which drives the auger 35, and the venturi nozzle 38.

Air to operate the control system 70 and its dependent controlled equipment is provided through shop air delivered through air supply inlet fitting 72. This incoming air supply is filtered by filter 85 upon entry into the control system. The incoming air supply is directly routed to the manual override valve 81, the first piloted valve 86, the venturi pressure regulator 87, and the motor pressure regulator 89. Motor pressure regulator 89 is mounted inside the control box 71, while the control knob of venturi pressure regulator 87 extends through the side of the box 71 for ready operator access.

Manual override valve 81 is a two-position three-way detented valve operated by a toggle switch that protrudes from the upper surface of the control box 71. A pneumatic pressure signal from the gun signal override switch 117, mounted on the spray gun 100, is routed to the control system 70 by means of a signal override tube 119 and enters the control system through a gun feedback inlet fitting 78. The pressure signals from the override valves 117 and 81 are combined by means of interconnecting the outputs from those valves to provide a pilot pressure for first piloted valve 86. Thus, the pilot signals from either selectably controllable valve 117 or valve 81 or both valves serve to operate valve 86. Accordingly, valve 86 serves as an OR logic gate.

The output from first piloted valve 86 provides operational air to the vibrator 25 by way of vibrator supply fitting 74 and a supply hose (not shown). Additionally, the output from valve 86 serves as a pilot signal for both the second 88 and the third 90 piloted valves. All three piloted valves 86, 88, and 90 are 2-position 3-way normally closed valves with single-acting pneumatic pilots and spring returns. Pressure regulators 87 and 89 respectively control the inlet air pressure to valves 88 and 90, which in turn respectively control the air delivery to operate the venturi nozzle 38 and the air motor 53. Pressure gauge 84, mounted on the cover of control box 71, is used to indicate the inlet pressure for valve 88 and the venturi nozzle 38. The air supply for the venturi nozzle 38 is delivered from valve 88 via venturi supply fitting 75 and a hose (not shown). The air supply for the air motor 53 is delivered from valve 90 via air motor supply fitting and a hose (not shown).

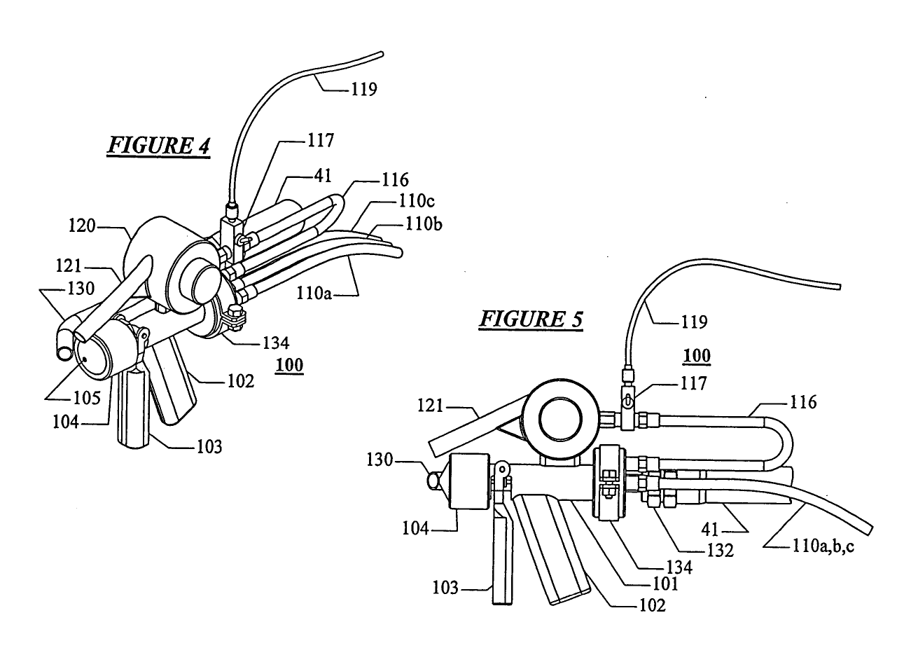

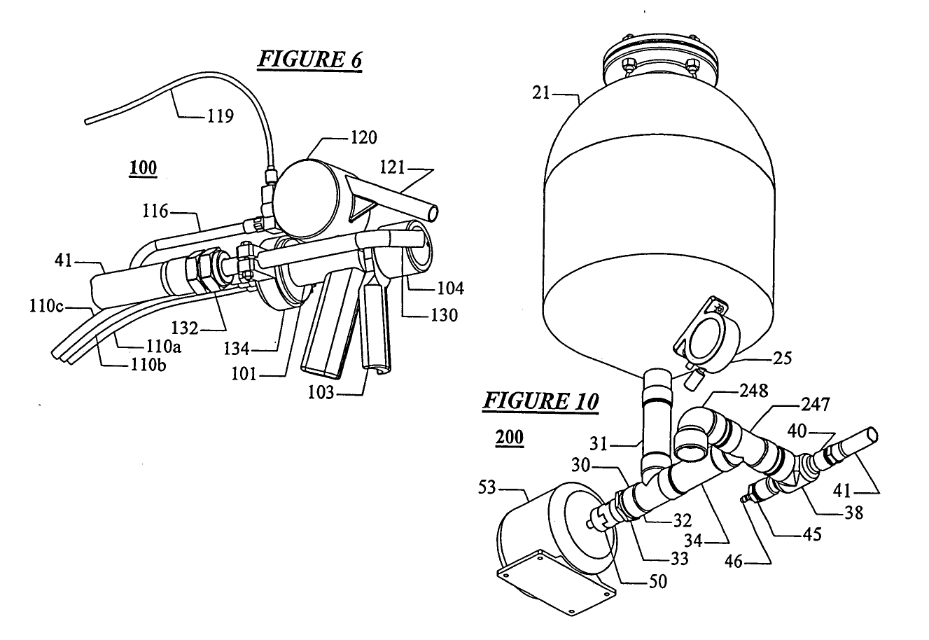

A spray gun 100, shown if FIGS. 4-6, is based on a conventional commercially available non-atomizing spray gun with an integral chopper attachment for cutting and feeding a stream of randomly oriented glass fibers. A wide variety of commercially available guns are used for spray layup of reinforced plastics; the spray gun 100 of this system is produced by adding a clamp-on filler injection nozzle 130 and a gun signal override switch 117 to such guns.

The typical spray gun 100 has a spray gun body 101 which normally has axially aligned stepped cylindrical body segments, a handle 102 projecting in a radial plane, and a trigger attached to the body at one end and rotatable in the same radial plane of the body defined by the handle. Air, resin, and catalyst are respectively supplied to the rear of the gun 100 by means of hoses 110a,b,c. The hoses 110a,b,c are connected to the rear of the body 100 by threading their end fittings into threaded ports. The threaded ports connect to internal passages and are routed to the mixing head 104 of the body 101 through the flow controlling mechanisms of the trigger 103. Since the particular mechanisms of the spray gun control are not part of the present invention and are well known to those skilled in the art, they are not described in detail herein.

The resin and catalyst are combined in the mixing head 104, located at the front of the body 101, and are ejected from the mixing head by means of one or more spray nozzles 105. The resin spray pattern of the gun 100 is substantially coaxial with the cylindrical body segments of the gun body 100.

The chopper 120 is a commercially provided pneumatically driven device which accepts an input skein or skeins of continuous glass fiber and expels cut segmental lengths of glass fiber into the resin spray coming out of the spray gun 100. For a commercially available spray gun, a chopper air supply line 116 normally extends in an U-shaped bend from the rear of the gun 100 to the chopper 120. The air for the chopper is provided by tapping into the main air supply for the gun, and a hose is normally used for air supply line 116. The cut glass fibers are injected into the spray pattern of the gun 100 through chopper nozzle 121, which extends to the discharge region of the gun.

For the purposes of the present invention, the normal arrangement for the chopper is modified by interposing a gun signal override valve 117 in the air supply line 116 at the chopper end. Valve 117 consists of an integral tee connection body with a manually operated double-detented two-position three-way valve located on the branch of the tee. The through flow for the chopper thus can pass through the body of valve 117, but flow and pressure can be diverted through the operable valve. When the operator of spray gun 100 switches the valve 117, flow and pressure can selectably be applied to override signal tube 119. Override signal tube 119 is connected to the control system 70 by means of gun feedback inlet fitting 78.

The filler injection nozzle 130 is a length of plastically deformable cylindrical tubing that is clamped to a cylindrical segment of the body 101 of spray gun 100 by means of a split ring filler nozzle mounting clamp 134. The tubing can be field bent so that it will properly induce the stream of filler into the spray pattern of the spray gun. The material of the filler injection nozzle 130 is conductive so that a buildup of static electricity on the nozzle is avoided, since it is grounded to the grounded gun body 101.

The delivery hose 41 is attached to the filler injection nozzle by means of standard hose-to-tube connector filler nozzle attachment fitting 132. The filler nozzle mounting clamp 134 has a rectangular block body with a transverse through hole closely fitted to the filler injection nozzle 130. A slot extends radially from the through hole and normally to an adjacent side of the block body, and a through hole perpendicular to the slot and threaded on one side of the slot intersects the slot. A clamp screw extends across the slot and is engaged in the threads of the through hole so that the nozzle 130 can be clamped. A conventional strap clamp held by a screw and nut is mounted on the opposed end of the mounting clamp body so that the mounting clamp 134 can be positioned on the body 101 of the spray gun 100. The clamping by clamp 134 is such that the tube of nozzle 130 is held parallel to and offset from the axis of the spray gun 100.

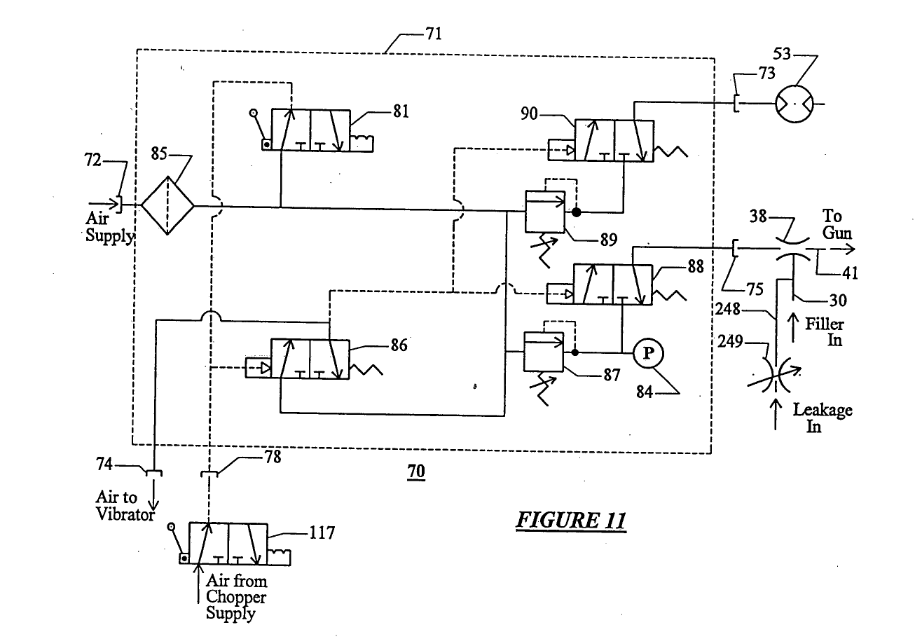

A second embodiment 200 of the filler injection system is shown in FIGS. 10 and 11. Filler injection system 200 utilizes all of the components of the first embodiment 10 of the present invention, but has two other components added to modify the system from that of the first embodiment. In this case, the outlet end of second long pipe nipple 34 is threadedly engaged into the non-through female bore of a 2 inch NPT tee fitting 247. Tee fitting 247 has male 2 inch NPT threads on its horizontally extending through bore branches. Downwardly opening 2 inch elbow fitting 248 is mounted on a first end of the through bore of tee 247, while the second end is attached to the venturi nozzle 38. In all other respects, the physical description of the two embodiments 10 and 200 are the same.

The schematic flow diagram shown in FIG. 11 also discloses a further modification of the second embodiment, wherein an optional valve 249 is attached in series with the elbow 248. Valve 249 can be selectably opened or closed or positioned intermediately between those two positions manually by the operator of the filler injector system 200. The valve 249 is upstream of elbow 248 in FIG. 11, but it could as easily be located between elbow 248 and tee 247. Varying the opening of the valve 249 varies the amount of vacuum in the venturi nozzle 38.

### OPERATION OF THE INVENTION

The first embodiment 10 of the present invention operates in the following manner. Air is supplied to the spray gun 100 and to the control system 70. If the spray gun 100 is on so that air is flowing to the chopper 120 and either the gun signal override switch 117 is open or the vibrator override valve is open or both are open, then air flows through the control system and to the vibrator 25, the venturi nozzle 38, and the air motor 53. When this occurs, the vibrator induces filler in the tank 21 to migrate under gravity to the lower end of the tank and thence into the first pipe nipple 31 of the feed auger system 30. Because the air motor/gear box combination 53 is rotating the auger 35, filler is thereby induced to move toward the venturi nozzle 38 by the auger. Since a low pressure is induced by the action of the air flow in the venturi nozzle 38, the filler is caused to enter the flow stream from the nozzle 38 and is thereby conveyed through hose 41 to the filler injection nozzle 130 on the gun 100. The flow of filler is there admixed with the glass fiber and resin spray emanating from the gun 100 so that a homogeneous and intimate mixture of the sprayed components occurs. This intimate mixing of the RF Fiber™ filler permits a chemical binding reaction between the styrene of the resin and the lignin of the filler, as well as direct absorption of styrene by the filler.

The air pressures of the flows for the venturi nozzle 35 and the air motor 53 are respectively controlled by pneumatic regulators 87 and 89. By this means, the speed of the auger 35 and the transfer rate of filler by the venturi nozzle are controlled. The operation of the vibrator 25, the auger 35, and the venturi 38 are normally slaved to the supply of air to the chopper on the spray gun and hence are controlled by the spray gun operator. However, the spray gun control valve 117 that is operated by its toggle switch permits disabling this control signal.

A second operator selective control valve 81 with a toggle switch is mounted on box 71 so that an operator can control the feed of filler independently of the operation of the spray gun mounted switch 117. If the gun signal override valve 117 is closed and the vibrator override valve 81 is open, then the feed of the filler operates independently of the trigger of the gun 100. If both valves 117 and 81 are closed, then the feed of the filler to the gun is prevented.

The first embodiment 10 of the filler injector system is capable of very high filler deliveries. However, in some cases, the delivery rate is too high for the application. This situation arises because the low pressure of the venturi nozzle 38 is sufficient to draw filler from tank 21 without the turning of the auger 35.

The second embodiment 200 of the filler injector system overcomes this drawback by providing a vacuum breaker teed into the connection between the feed auger system 30 and the venturi nozzle 38. Tee connection 247 and attached open ended elbow 248 admit atmospheric air to the venturi nozzle 38 connection to the feed auger system 30 to eliminate the action of the venturi vacuum on the tank 21. The circuit for the system 200, shown in FIG. 10, is schematically illustrated in FIG. 11 with the addition of the optional variable orifice valve 249 in series with the elbow. The valve 249, for controlling the amount of air admitted into the region of the throat of the venturi nozzle 38, provides an additional means for providing fine control of the feed rate of the filler to the spray gun 100.

When valve 249 is wide open, then filler is supplied to the venturi nozzle 38 only through action of the feed auger system 30. Likewise, when valve 249 is fully closed, the operation of the filler injection system 200 is identical to that of the filler injection system 100. Intermediate positions of valve 249 result in filler delivery rates between those two extremes. The advantage of this approach is that the operator can very closely and easily control the delivery rate of the filler by varying one or more of the controllable factors for the system. Thus any one of the three controllable factors, or any combination of the three controllable factors, can be varied to control the delivery of filler to the spray gun 100. The three controllable factors are air motor pressure, venturi pressure, and the pressure communicated to the tank 21 through the feed auger system 30 from the venturi nozzle. These three variables are respectively controlled by the regulator 89, the regulator 87, and the opening of valve 249.

### ADVANTAGES OF THE INVENTION

A major advantage of the present invention is the ability to carefully control the rate of filler injection into the fiberglass-resin stream. This rate of filler injection is controllable by multiple independent means for both embodiments of the present invention and is readily adjustable to compensate for any desired changes in filler amounts in the sprayed resin or other factors.

The feed auger, if used alone as in most systems, can in some cases exceed the ability of the venturi nozzle to deliver the filler to the spray gun. Likewise, the feed auger alone may have an insufficient delivery rate for a spraying application. Similarly, a venturi nozzle alone may not be able to deliver sufficient filler for an efficient spraying operation, and in other cases may deliver too much. By providing dual, interactive means for delivering filler from the tank to the spray gun, a much more controllable and reliable system results.

For the first embodiment, the auger, aided by the vacuum of the venturi is able to deliver much more filler than competitive systems. The level of vacuum provided by the venturi is adjusted so that more filler is entrained by the venturi action than is delivered to the venturi nozzle by the combination of the venturi action and the auger.

For the second embodiment, provision of the vacuum breaker enables lower filler deliveries for spraying situations that require less. Provision of an operable valve mounted on the vacuum breaker permits modulation of the action of the vacuum breaker.

Having described several embodiments securing pressure-containing equipment, it is believed that other modifications, variations, and changes will be suggested to those skilled in the art in view of the description set forth above. It is therefore to be understood that all such variations, modifications, and changes are believed to fall within the scope of the invention as defined in the appended claims.

What is claimed is:

1. An apparatus for spraying reinforced plastic resin comprising:
(a) an air supply;
(b) a filler feed system having
an air motor in communication with the air supply,
an auger rotated by the air motor,
a filler supply tank feeding a filler material into the auger, and
a venturi nozzle, wherein rotation of the auger delivers the filler material to the venturi nozzle and the filler material emanates from the venturi nozzle at a rate controlled by a rate of rotation of the auger and the venturi air supply pressure; and
(c) a spray gun delivering a resin stream, a chopped glass stream, and a stream of filler material.

2. The apparatus of claim 1, further comprising a control system for controlling the delivery of the resin stream, the chopped glass stream, and the stream of filler material.

3. The apparatus of claim 1, wherein the filler feed system further comprises a vibrator to assist smooth the flow of the filler material from the filler supply tank into the auger.

4. The apparatus of claim 1, wherein the filler feed system further comprises a counting means for counting a number of auger rotations.

5. The apparatus of claim 1, further comprising a valve for controlling air volume delivered to the venturi nozzle.

6. The apparatus of claim 1, wherein the spray gun comprises
a spray gun body,
a mixing head,
a spray nozzle in communication with the mixing head,
a chopper gun,
a chopper nozzle, and
a filler injection nozzle in communication with the venturi nozzle.

7. The apparatus of claim 6, wherein the stream of chopped glass emanates from the chopper nozzle, the resin stream emanates from the spray nozzle, and the stream of filler material emanates from the filler injection nozzle.

8. The apparatus of claim 7, wherein the resin stream, the chopped glass stream, and the stream of filler material are mixed together during spraying.

9. The apparatus of claim 6, further comprising an injection control means for controlling the delivery of the resin stream, the chopped glass stream, and the stream of filler material.

10. The apparatus of claim 1, wherein the air motor includes a gear box.

11. An apparatus for spraying reinforced plastic resin comprising:
(a) an air supply;
(b) a filler feed system having
an air motor in communication with the air supply,
an auger rotated by the air motor,
a filler supply tank feeding a filler material into the auger, and
a venturi nozzle, wherein rotation of the auger delivers the filler material to the venturi nozzle and the filler material emanates from the venturi nozzle at a rate controlled by a rate of rotation of the auger and the venturi air supply pressure; and
(c) a spray gun delivering a resin stream, a chopped glass stream, and a stream of filler material, the spray gun including
a spray gun body,
a mixing head,
a spray nozzle in communication with the mixing head,
a chopper gun,
a chopper nozzle, and
a filler injection nozzle in communication with the venturi nozzle.

12. The apparatus of claim 11, wherein the air motor includes a gear box.

13. A process for spraying reinforced plastic resin using the apparatus of claim 1.

14. The process of claim 13, wherein the filler material is a natural fiber.

15. The process of claim 14, wherein the natural fiber has a high lignin content.

16. The process of claim 13 further comprising the step of controlling a rate of delivery of the resin stream, the chopped glass stream, and the stream of filler material.
